(19) United States
(12) Patent Application Publication
(10) Pub. No.: US 2006/0213449 A1
(43) Pub. Date: Sep. 28, 2006

(54) Apparatus and method for repelling animals

(76) Inventor: Cory Jerome Dodge, Blaine, WA (US)

Correspondence Address: David O. Simmons;Galasso & Associates LP, P.O. Box 26503, Austin, TX, 78755-0503, US

(21) Appl. No.: 11/388,552

(22) Filed: Mar. 24, 2006

Related U.S. Application Data
(60) Provisional application No. 60/665,569, filed on Mar. 25, 2005.

(51) Int. Cl. A01K 31/14

(52) U.S. Cl. 119/329

(57) ABSTRACT

An animal repelling apparatus comprises a motion-sensing device, a water reservoir tank, a water nozzle and a water-pressurizing device. The water-pressurizing device is fluid-communicatively connected to the water reservoir tank for receiving water from the water reservoir tank. The water-pressurizing device is electrically connected to the motion-sensing device for pressurizing water received from the water reservoir tank when the motion-sensing device senses motion of an object within a prescribed area adjacent thereto. The water-pressurizing device is fluid-communicatively connected to the water nozzle for delivering the pressurized water to the water nozzle such that the pressurized water is sprayed from the water nozzle.

### CROSS REFERENCE TO RELATED APPLICATIONS

This patent application claims priority to co-pending U.S. Provisional Patent Application having Ser. No. 60/665,569 filed Mar. 25, 2005 entitled “Cat Scat”, having a common applicant herewith and being incorporated herein in its entirety by reference.

### FIELD OF THE DISCLOSURE

The disclosures made herein relate generally to apparatuses and methods for repelling animals from designated locations and, more particularly, to apparatuses and methods that use pressurized water for repelling animal from a designated location.

### BACKGROUND

Animals, whether domesticated or wild, are known to engage in activities that are bothersome and/or destructive to people. Examples of such activities include, but are not limited to, digging in yards, resting on cars, chasing other animals and defecating in inappropriate areas. While the animal may well not know that such activities are bothersome and/or destructive, it is nevertheless a strong desire of many people to act upon such animals to stop them from engaging in such activities. That said, in stopping animals from engaging in such bothersome and/or destructive activities, people typically do not wish to harm such animals.

Therefore, an approach for repelling animals from certain areas in a manner that is effective, yet safe and humane, would be advantageous, desirable and useful.

### SUMMARY OF THE DISCLOSURE

In one embodiment of the present invention, an animal repelling apparatus comprises a motion-sensing device, a water reservoir tank, a water nozzle and a water-pressurizing device. The water-pressurizing device is fluid-communicatively connected to the water reservoir tank for receiving water from the water reservoir tank. The water-pressurizing device is electrically connected to the motion-sensing device for pressurizing water received from the water reservoir tank when the motion-sensing device senses motion of an object within a prescribed area adjacent thereto. The water-pressurizing device is fluid-communicatively connected to the water nozzle for delivering the pressurized water to the water nozzle such that the pressurized water is sprayed from the water nozzle.

In another embodiment of the present invention, an animal repelling apparatus comprises a housing, a motion-sensing device, a water nozzle and a water pump. The housing has an exterior surface at least partially contoured in a shape of an animal and having a hollow interior space therein. The motion-sensing device is at least partially disposed within the hollow interior space. The water nozzle is attached to the housing. An outlet of the water nozzle is outside of the hollow interior space and an inlet of the water nozzle is within the hollow interior space. The water pump is at least partially disposed within the hollow interior space. The water pump is fluid-communicatively connected to a water supply for receiving water therefrom. The water pump is electrically connected to the motion-sensing device for pressurizing water received from the water supply when the motion-sensing device senses motion of an object within a prescribed area adjacent thereto. The water pump is fluid-communicatively connected to the inlet of the water nozzle for delivering the pressurized water to the water nozzle such that the pressurized water is sprayed out of the outlet of the water nozzle.

In another embodiment of the present invention, a method for repelling animals comprises a plurality of operations. An operation is performed for sensing presence of an animal within a prescribed area. An operation is performed for activating a water-pressuring device after sensing presence of the animal. The operation of activating causes water to be received from a water reservoir tank and causes the water to be pressurized in conjunction with receiving the water. An operation is performed for spraying the pressurized water from a water nozzle into the prescribed area after generating the pressurized water.

Turning now to specific aspects of the present invention, in at least one embodiment, a water reservoir tank is at least partially disposed within the hollow interior space and the water reservoir tank is the water supply from which water is received by the water pressuring device.

In at least one embodiment of the present invention, the water reservoir tank is integrally formed with at least a portion of the housing.

In at least one embodiment of the present invention, the exterior surface of the housing is contoured to closely resemble the shape of an animal.

In at least one embodiment of the present invention, a solar panel is connected to the water pump for supplying electrical power thereto and a light impingement portion of the solar panel is outside of the hollow interior space of the housing.

In at least one embodiment of the present invention, the water pump is disposed within the water reservoir tank such that the water pump becomes at least partially covered with water when water is within the water reservoir tank.

In at least one embodiment of the present invention, an operation is performed for supplying electrical power to the pump in response to sensing of an animal being performed.

In at least one embodiment of the present invention, an operation is performed for deactivating a water-pressurizing device after a prescribed period of time passes from activating of the water-pressuring device being performed.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a partially cut-away perspective view showing an embodiment of an animal repelling apparatus in accordance with the present invention.

### DETAILED DESCRIPTION OF THE DRAWING FIGURES

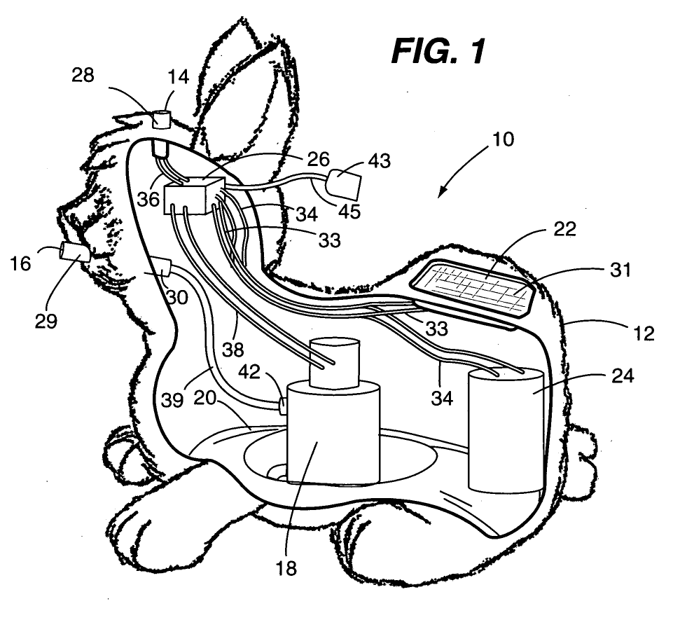

FIG. 1 depicts an embodiment of an animal repelling apparatus in accordance with the present invention, which is referred to herein as the animal repelling apparatus 10. The animal repelling apparatus 10 is configured for repelling animals in a manner that is effective, yet safe and humane. Water is selectively sprayed from the animal repelling apparatus 12 under relatively high pressure to scare animals within and/or near the spray of water.

The animal repelling apparatus 10 includes a housing 12, a motion-sensing device 14, a water nozzle 16, a water pump 18, a water reservoir tank 20, a solar panel 22, a battery 24 and a control unit 26. Preferably, but not necessarily, an exterior surface of the housing 12 is at least partially contoured to resemble a shape of an animal such as, for example, a rabbit, a cat, a dog, a squirrel, a racoon and a snake. It is disclosed herein that an exterior surface of the housing 12 may also be at least partially contoured to resemble a shape of an object such as, for example, a log, a rock and a flowerpot. The present invention is not unnecessarily limited to a particular exterior shape of the housing 12.

The housing 12 includes a hollow interior space in which the water pump 18, the water reservoir tank 20, the battery 24 and the control unit 26 are mounted. The motion-sensing device 14 is attached to the housing 12 such that a sensing portion 28 of the motion-sensing device 14 is exposed outside of the hollow interior space of the housing 12. The water nozzle 16 is attached to the housing 12 such that a nozzle outlet portion 29 of the water nozzle 16 is exposed outside of the hollow interior space of the housing 12 and a water inlet portion 30 is exposed within the hollow interior space of the housing 12. The solar panel 22 is attached to the housing 12 such that a light impingement surface 31 of the solar panel 22 is exposed outside of the housing 12.

The water reservoir tank 20 may be a discrete tank mounted within the hollow interior space of the housing 12 or may be integrally formed with the housing 12 (e.g., molded in combination with all or a portion of the housing 12). In one embodiment, the water reservoir tank is an enclosed tank having a water supply inlet (e.g., garden hose connector) that is connected to the water reservoir tank 20. In this embodiment, the water reservoir tank is an enclosed tank having a water supply inlet 21 that extends outside of the hollow interior space of the housing 12. In this embodiment, the water supply inlet 21 enables water to be supplied to the water reservoir tank 20 via a pressurized source such as via a garden hose. In another embodiment, the water reservoir tank 20 is omitted and water is supplied directly to the water pump 18 from a water supply such as, for example, a remote water reservoir tank or a garden hose. In still another embodiment, the water reservoir tank 20 is an open tank, having an open top portion through which the water reservoir tank 20 is filled.

The motion-sensing device 14 senses presence of an object moving relative to a position of the housing 12. The water pump 18 pressurizes water received from the water reservoir tank 20. The solar panel 22 generates electrical power from solar rays (e.g., UV rays of sunlight). The battery 24 stores electrical power generated by the solar panel 22. The control unit 26 facilitates distribution of electrical power from the solar panel 22 to the water pump 18 (i.e., electrical power supply during daylight hours), from the solar panel 22 to the battery 24 (i.e., battery charging during daylight hours) and/or from the battery 24 to the water pump 18 (i.e., electrical power supply during non-daylight hours).

Electrical conductors 32 are connected between the motion-sensing device 14 and the control unit 26 for enabling a control signal to be provided to the control unit 26 when the motion-sensing device 14 detects presence of a moving object (e.g., an animal) within a prescribed area adjacent to the motion-sensing device 14. It is disclosed herein that the motion-sensing device 14 may sense objects within an area 360-degrees around the motion-sensing device 14 or an area less than 360-degrees around the motion-sensing device 14. It is also disclosed herein that a radial distance of sensing may be adjustable, an angular sensing range may be adjustable or both.

Electrical conductors 33 are connected between the solar panel 22 and the control unit 16 for supplying electrical power from the solar panel 22 to the control unit 16. Electrical conductors 34 are connected between the control unit 16 and the battery 24 for supplying electrical power from the battery 24 to the control unit 16 and/or for supplying electrical power from the control unit 16 to the battery 24 (i.e., for charging the battery). Electrical conductors 36 are connected between the control unit 16 and a motor of the water pump 18 for distributing electrical power from the control unit 16 to the motor 38 of the water pump 18.

In embodiments where the water reservoir tank 20 is an open tank having an open top portion through which the water reservoir tank 20 is filled, the control unit 16 at a location where the probability of exposure to water is reduced. For example, where the exterior surface of the housing 12 is at least partially contoured to resemble a shape of an animal, the control unit 16 is located within a portion of the housing corresponding to a head of the animal and the water reservoir tank 20 is located in a portion of the housing corresponding to a torso (e.g., belly) of the animal.

A power connector 43 is connected to the control unit 16 via a plurality of conductors 45 for enabling electrical power to be supplied to the control unit 16 from an external source such as for example, a wall socket, a power converter/adapter a battery charger, a low voltage power supply, etc. In one embodiment, the power connector 43 is exposed outside of the hollow interior space of the housing 12. In another embodiment, the power connector 43 is accessible from within the hollow interior space of the housing 12. It is disclosed herein that the solar panel 22 and/or the battery 24 may be omitted such that electrical power is supplied exclusively from an external source of electrical power (e.g., a wall socket, a power converter/adapter a battery charger, a low voltage power supply).

It is disclosed herein that more than two or less than two conductors may be connected between the motion-sensing device 14, the water pump 18, the solar panel 22, the battery 24 and/or the control unit 26. The specific number of electrical conductors will depend on the specific electrical configuration of the motion-sensing device 14, the water pump 18, the solar panel 22, the battery 24 and the control unit 26. The present invention is not limited to a particular number of electrical conductors connected between components of the animal repelling apparatus 10.

A water outlet 39 of the water pump 18 is connected to the inlet portion 30 of the water nozzle 16 by a water delivery tube 44 for enabling pressurized water to be delivered to the water nozzle 16. Where the water reservoir tank 20 is an open tank or a substantially enclosed tank, the water pump 18 may be located within the water reservoir tank 20 such that the water pump 18 becomes at least partially covered with water when water is within the water reservoir tank 20. A water inlet of the water pump 18 (e.g., on a bottom face of the water pump 18 or on a side face of the water pump 18) enables water to be drawn into the water pump 18 so long as the water inlet of the water pump 18 remains submerged in the water. Optionally, the water pump 18 may be externally located with respect to the water reservoir tank 20 such that a water supply tube routes water from the water reservoir tank 20 to the water inlet of the water pump 18.

In operation, the motion-sensing device 14 senses presence of a moving object (i.e., preferably an animal) within a prescribed area adjacent to or surrounding the motion-sensing device 14. In response to sensing the presence of the moving object, electrical power is supplied to the water pump 18 for activating the water pump 18. Activation of the water pump 18 causes water to be received by the water pump 18 from the water reservoir tank 20 and causes the water received from the water reservoir tank 20 to be pressurized by the water pump 18. The pressurized water is delivered to the water nozzle 16 and is correspondingly sprayed from the water nozzle 16 into a prescribed area. The water nozzle 16 may be adjustable such that the prescribed area into which the pressurized water is sprayed may be an area 360-degrees around the water nozzle 16 or an area less than 360-degrees around the water nozzle 16. It is also disclosed herein that a radial distance of that the pressurized water is sprayed may be adjustable, an angular spray pattern of the water nozzle 16 may be adjustable or both. The water pump 18 is deactivated after a prescribed period of time passes from when the water pump 18 is activated or after the motion-sensing device 14 senses that the moving object that was initially sensed is no longer within the sensing range of the motion-sensing device 14.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An animal repelling apparatus, comprising:
a motion-sensing device;
a water reservoir tank;
a water nozzle; and
a water pump mounted for receiving water from the water reservoir tank, electrically connected to the motion-sensing device for pressurizing water received from the water reservoir tank when the motion-sensing device senses motion of an object within a prescribed area adjacent thereto and fluid-communicatively connected to the water nozzle for delivering said pressurized water to the water nozzle such that said pressurized water is sprayed from the water nozzle.

2. The animal repelling apparatus of claim 1, further comprising:
a solar panel connected to the water pump for supplying electrical power thereto.

3. The animal repelling apparatus of claim 1 wherein:
the water pump is disposed within the water reservoir tank such that the water pump becomes at least partially covered with water when water is within the water reservoir tank.

4. The animal repelling apparatus of claim 3, further comprising:
a housing having a hollow interior space, wherein the motion-sensing device is at least partially disposed within the hollow interior space, wherein an outlet of the water nozzle is outside of the hollow interior space, wherein an inlet of the water nozzle is within the hollow interior space and wherein the water pump at least partially disposed within the hollow interior space.

5. The animal repelling apparatus of claim 4, further comprising:
a solar panel connected to the water pump for supplying electrical power thereto, wherein a light impingement portion of the solar panel is outside of the hollow interior space of the housing.

6. An animal repelling apparatus, comprising:
a housing having an exterior surface at least partially contoured in a shape of an animal and having a hollow interior space;
a motion-sensing device at least partially disposed within the hollow interior space;
a water nozzle attached to the housing, wherein an outlet of the water nozzle is outside of the hollow interior space and an inlet of the water nozzle is within the hollow interior space; and
a water pump at least partially disposed within the hollow interior space, wherein the water pump mounted for receiving water from a water supply, wherein the water pump is electrically connected to the motion-sensing device for pressurizing water received from the water supply when the motion-sensing device senses motion of an object within a prescribed area adjacent thereto and wherein the water pump is fluid-communicatively connected to the inlet of the water nozzle for delivering said pressurized water to the water nozzle such that said pressurized water is sprayed out of the outlet of the water nozzle.

7. The animal repelling apparatus of claim 6, further comprising:
a water reservoir tank at least partially disposed within the hollow interior space, wherein the water reservoir tank is the water supply from which said water is received by the water pump.

8. The animal repelling apparatus of claim 1 wherein:
the water pump is disposed within the water reservoir tank such that the water pump becomes at least partially covered with water when water is within the water reservoir tank.

9. The animal repelling apparatus of claim 8 wherein the water reservoir tank is integrally formed with at least a portion of the housing.

10. The animal repelling apparatus of claim 9, further comprising a control unit electrically connected between the water pump and the motion sensor, wherein the control unit supplies electrical power to the water pump when the motion sensor senses movement of an object, wherein the exterior surface of the housing is contoured to closely resemble the shape of an animal, wherein the housing includes a portion resembling a head of an animal and a portion resembling a torso of an animal, wherein the control unit is located in the portion resembling the head and wherein the water reservoir tank is located in the portion resembling the torso.

11. The animal repelling apparatus of claim 10, further comprising:
a solar panel connected to the water pump for supplying electrical power thereto, wherein a light impingement portion of the solar panel is outside of the hollow interior space of the housing.

12. A method for repelling animals, comprising:
sensing presence of an animal within a prescribed area;
activating a water pressuring device after performing said sensing, wherein said activating causes water to be received from a water reservoir tank and causes said water to be pressurized in conjunction with receiving said water; and
spraying said pressurized water from a water nozzle into the prescribed area after generating said pressurized water.

13. The method of claim 12, further comprising:
supplying electrical power to the pump in response to said sensing being performed, wherein said activating is performed in response to said supplying electrical power being performed.

14. The method of claim 13, further comprising:
deactivating the water pump after a prescribed period of time passes from said activating of the water pump being performed.
